(19) United States
(12) Patent Application Publication
(10) Pub. No.: US 2019/0324418 A1
(43) Pub. Date: Oct. 24, 2019

(54) Electric Drive System and Method of Operating the Electric Drive System

(71) Applicant: Lenze Automation GmbH, Aerzen (DE)

(72) Inventors: Johannes KUEHN, Braunschweig (DE); Detlef PECKMANN, Braunschweig (DE)

(21) Appl. No.: 16/389,044

(22) Filed: Apr. 19, 2019

(30) Foreign Application Priority Data
Apr. 20, 2018 (DE) 10 2018 206 117.3

(51) Int. Cl. G05B 19/042; G06F 13/40

(52) U.S. Cl. CPC G05B 19/0423; G06F 13/4068

(57) ABSTRACT

An electric drive system has a multiplicity of electrical controllers, the electrical controllers each having a nonvolatile memory that is configured to store controller data of the respective controller, and a bus system. The multiplicity of electrical controllers are able to be coupled to one another by way of the bus system in order to exchange data. The electrical controllers are each configured to store controller data of other controllers in their memory.

### BACKGROUND AND SUMMARY OF THE INVENTION

The invention relates to an electric drive system and to a method for operating an electric drive system.

The invention is based on the object of providing an electric drive system and a method for operating an electric drive system that exhibit high operational security and easy maintenance.

The invention achieves this object through an electric drive system having a multiplicity of electrical controllers, the electrical controllers each having: a memory that is configured to store controller data of the respective controller, and a bus system. The multiplicity of electrical controllers are able to be coupled to one another by way of the bus system in order to exchange data, wherein the electrical controllers are each configured to store controller data of other controllers in their memory. The invention further achieves this object by a method for operating an electric drive system wherein, when changing the controller data in a respective controller, the changed controller data are stored in the memory of at least one other controller.

The electric drive system has a multiplicity of electrical controllers. The electric drive system may have for example between 2 and 50 electrical controllers.

A respective electrical controller has an in particular nonvolatile electrical memory, in particular internal to the controller, which is designed to store controller data of the respective controller, in particular store them in a nonvolatile manner. The memory may be a non-removable, that is to say fixedly installed, memory. The memory may be for example a flash memory.

The electric drive system furthermore has a conventional bus system, in particular a field bus system. The bus system may be for example an EtherNet/IP bus system, a DeviceNet bus system, a Profibus bus system, an EtherCAT bus system, an INTERBUS bus system, etc. The electrical controllers are able to be coupled to one another or are coupled to one another in a conventional manner by way of the bus system in order to exchange data.

The electrical controllers are each designed to store controller data of other controllers in their own memory. In this case, a respective controller may store for example all of the controller data of all of the other controllers, or store all of the controller data of just some of the multiplicity of controllers, or store just some of the controller data of all of the other controllers, or store just some of the controller data of just some of the multiplicity of controllers.

According to one embodiment, the respective controller data contain process data of a respective electrical controller and/or program code of a respective electrical controller and/or operating parameters of a respective electrical controller and/or logbook data of a respective electrical controller. Process data may be for example all (changeable) data that arise during operation of the controller. Program code may for example bring about the operation of the electrical controller when it is executed. Program code may be for example firmware and/or an application program of the electrical controller. Operating parameters may for example be those parameters whose values influence the mode of operation/type of operation of the electrical controller. Logbook data may be for example data required for subsequent evaluation of the operation of the electrical controller.

According to one embodiment, the electric drive system has at least one electric motor, wherein at least one of the electrical controllers is a frequency converter that is designed to drive the at least one electric motor. All of the electrical controllers may also be frequency converters that serve to drive a respectively connected electric motor. The electrical controllers may all be of the same type, for example all form frequency converters. As an alternative, at least one of the controllers may be a superordinate controller, which for example provides superordinate functions within the drive system.

The method according to the invention serves to operate an electric drive system described above. When changing the controller data in a respective controller, the changed controller data are stored in the memory of at least one other controller.

According to one embodiment, when exchanging a respective controller for a replacement controller, operating data from the exchanged controller that are stored in the memory of at least one other controller are transferred from the at least one other controller to the replacement controller and then stored in the memory of the replacement controller.

Electrical controllers or frequency converters generally have electrical (interchangeable) memories (for example an SD card, a memory stick, etc.). The memory is used for example to store programs or program code, to store (operating) parameters, to store logbooks or logbook data and to store process data.

If an electrical controller has to be exchanged for example due to a defect, then the memory of the controller to be exchanged is usually removed from the controller to be exchanged and inserted into a replacement controller. However, this may be connected with problems, since the memory may be defective or required to reconstruct an error in the controller to be exchanged. It is furthermore necessary to know how the memory should be exchanged. A further problem is the reading of process data, which is typically possible only very slowly via the bus system or directly on the device. If the memory is faulty or is destroyed, then it has to be filled again. This is generally performed on a software basis by way of a service notebook, which often requires Internet access.

These disadvantages are able to be avoided according to the invention. Data of a respective controller are automatically redundantly stored in other controllers. For example, process data, any desired parameters, in particular in the form of operating parameters, may thus be stored automatically in other controllers. The controllers provide the drive system with unnecessary memories. In the event of a defect with or failure of a controller, the data required for the replacement controller are loaded from one or more of the other controllers into the replacement controller. In a system analysis, process data, torques, frequency analyses, logbooks, formulae etc. are available.

A respective controller functions in this case as a local cloud server, wherein a raid mechanism is able to be provided by way of the multiplicity of controllers in a network, by way of which raid mechanism it is possible to achieve automatic drive system-wide data security. When a controller is exchanged, all of the necessary data/programs are able to be played back on the replacement controller, thus giving a self-healing mechanism.

There is additionally the possibility of combining the memories of the controllers, such that larger amounts of data are able to be held in total than in individual devices. There is also the possibility that individual controllers are able to process larger amounts of data than would be possible without a controller network.

This results in lower hardware costs for the converters, since it is not necessary to keep aside any dedicated memories for the backup of the controller data, in lower exchange expenditure, in higher data security, in lower logistical expenditure and in an additional use for what is known as Industry 4.0, in particular in the context of what are known as drive-based frequency converters without central control and without an Internet connection.

The bus system or the field bus in this case serves both for automatic data exchange for the cloud data and for memory alignment.

The invention is described in detail below with reference to the drawing.

### BRIEF DESCRIPTION OF THE DRAWING

FIG. 1 shows an electric drive system according to the invention.

### DETAILED DESCRIPTION OF THE DRAWING

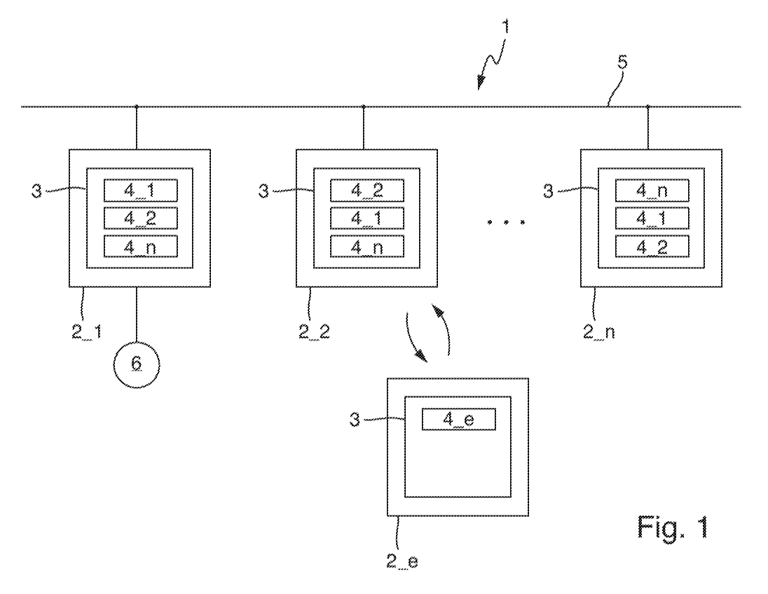

FIG. 1 shows an electric drive system 1 with a multiplicity of electrical controllers 2_1, . . . , 2_n in the form of frequency converters. “n” denotes a natural integer whose range of values may lie for example between 2 and 50.

The electrical controllers 2_1, . . . , 2_n each have a nonvolatile memory 3 that is designed to store controller data 4_1, . . . , 4_n of the respective controller 2_1, . . . , 2_n. In this case, the reference sign 4_1 denotes controller data of the controller 2_1, the reference sign 4_2 denotes controller data of the controller 2_2 and the reference sign 4_n denotes controller data of the controller 2_n.

The electric drive system 1 furthermore has a field bus system 5, wherein the multiplicity of electrical controllers 2_1, . . . , 2_n are coupled to one another by way of the field bus system 5 in order to exchange data.

As illustrated symbolically, the electrical controllers 2_1, . . . , 2_n are each designed to store controller data 4_1, . . . , 4_n of other controllers 2_1, . . . , 2_n in their memory 3.

In addition to its own controller data 4_1, the controller 2_1 thus also stores the controller data 4_2 and 4_n of the controllers 2_2, respectively 2_n. In addition to its own controller data 4_2, the controller 2_2 also stores the controller data 4_1 and 4_n of the controllers 2_1, respectively 2_n. In addition to its own controller data 4_n, the controller 2_n also stores the controller data 4_1 and 4_2 of the controllers 2_1, respectively 2_2.

The controller data may be for example process data of a respective controller 2_1, . . . , 2_n and/or program code of a respective electrical controller 2_1, . . . , 2_n and/or operating parameters of a respective electrical controller 2_1, . . . , 2_n and/or logbook data of a respective electrical controller 2_1, . . . , 2_n.

The electric drive system 1 furthermore has an electric motor 6, wherein the controller 2_1 is designed to drive the electric motor 6. It is understood that further electric motors, not illustrated, may be present, which are driven by way of an associated frequency converter 2_2 to 2_n.

The controllers 2_1 to 2_n are designed such that, when changing the controller data 4_1, . . . , 4_n in a respective controller 2_1, . . . , 2_n, the changed controller data 4_1, . . . , 4_n are stored or updated in the memory 3 of at least one other controller 2_1, . . . , 2_n.

An exchange of the controller 2_2 for a replacement controller 2_e is described below.

The operating data 4_2 of the exchanged controller 2_2, which are stored in the memory 3 of the controller 2_1 and 2_n, are transferred from one of the other controllers 2_1, respectively 2_n to the replacement controller 2_e, whereupon the replacement controller 2_e stores the operating data 4_2 in its own memory 3 and thus has memory content that corresponds to the exchanged controller 2_2. A burdensome manual memory update of the memory 3 of the replacement controller 2_e is therefore not necessary.

1-5. (canceled)

6. An electric drive system, comprising:
a multiplicity of electrical controllers, the electrical controllers each having a memory that is configured to store controller data of the respective controller; and
a bus system, wherein
the multiplicity of electrical controllers are coupleable to one another by way of the bus system in order to exchange data, and
the electrical controllers are each configured to store controller data of other controllers in their memory.

7. The electric drive system according to claim 6, wherein
the respective controller data contain one or more of:
process data of a respective electrical controller,
program code of a respective electrical controller,
operating parameters of a respective electrical controller, and
logbook data of a respective electrical controller.

8. The electric drive system according to claim 6, further comprising:
at least one electric motor, wherein
at least one of the electrical controllers is a frequency converter that is configured to drive the at least one electric motor.

9. The electric drive system according to claim 6, wherein
the memory is a non-volatile memory.

10. A method for operating an electric drive system having a multiplicity of electrical controllers, the electrical controllers each having a nonvolatile memory that is configured to store controller data of the respective controller; and a bus system, the multiplicity of electrical controllers being able to be coupled to one another by way of the bus system in order to exchange data, wherein the electrical controllers are each configured to store controller data of other controllers in their memory, the method comprising the step of:
when changing the controller data in a respective controller, storing the changed controller data in the memory of at least one other controller.

11. The method according to claim 10,
wherein
when exchanging a respective controller for a replacement controller, operating data of the exchanged controller that are stored in the memory of another controller are transferred from the other controller to the replacement controller and then stored in the memory of the replacement controller.
